(19) United States
(12) Patent Application Publication
(10) Pub. No.: US 2007/0187520 A1
(43) Pub. Date: Aug. 16, 2007

(54) Multi-zone temperature control module for an air handling system of a heating, ventilation, and air conditioning system for a vehicle

(76) Inventors: Timothy James Hall, Novi, MI (US); Eric Keith Haupt, Livonia, MI (US)

Correspondence Address: FRASER CLEMENS MARTIN & MILLER LLC, 28366 KENSINGTON LANE, PERRYSBURG, OH, 43551, US

(21) Appl. No.: 11/352,871

(22) Filed: Feb. 13, 2006

(51) Int. Cl. G05D 23/13; F25D 17/04

(52) U.S. Cl. 236/12.12; 62/186

(57) ABSTRACT

A multi-zone temperature control system for an air handling system of a heating, ventilating, and air conditioning system for a vehicle is disclosed, wherein a cost and a space requirement for the system are minimized and a control of temperature in a passenger compartment of the vehicle is optimized.

### FIELD OF THE INVENTION

The invention relates to a climate control system for a vehicle and more particularly to a multi-zone temperature control module for an air handling system of a heating, ventilating, and air conditioning system for the vehicle.

### BACKGROUND OF THE INVENTION

A vehicle typically includes a climate control system which maintains a temperature within a passenger compartment of the vehicle at a comfortable level by providing heating, cooling, and ventilation. Comfort is maintained in the passenger compartment by an integrated mechanism referred to in the art as a heating, ventilation and air conditioning (HVAC) air-handling system. The HVAC air-handling system conditions air flowing therethrough and distributes the conditioned air throughout the passenger compartment.

Vehicle passengers often prefer personalized comfort within a specific zone of the passenger compartment. This can be provided by individualized temperature control. In order to accomplish individualized temperature control within the passenger compartment, the passenger compartment is divided into independent temperature control zones.

Individualized temperature control is often referred to in the art as multi-zone temperature control. For example, one zone may be a front seat portion of the passenger compartment of the vehicle. This zone can be subdivided into a front driver-side zone and a front passenger-side zone. Another zone may be the rear passenger portion of the vehicle. This zone can also be subdivided into a rear driver-side zone and a rear passenger-side zone.

Preferably, the temperature within each zone can be independently controlled. As is known in the art, dual-zone temperature control typically refers to independent temperature control of two zones including the front driver-side zone and the front passenger side zone. Similarly, tri-zone temperature control typically refers to independent temperature control of three zones including the front driver-side zone, the front passenger side zone.

Prior art multi-zone temperature control has been provided by an auxiliary HVAC air-handling system for the rear zone in the vehicle. While the prior art auxiliary rear HVAC air-handling systems perform adequately, the systems add cost to the vehicle and require significant additional packaging space within the vehicle.

Multi-zone temperature control has also been provided by partitioning the HVAC air-handling system into multiple parallel chambers which correspond to a desired number of independent temperature zones. While the partitioned HVAC air-handling systems also perform adequately, a unique HVAC air-handling system is required for each type of system, such as a single zone, a dual zone, and a tri-zone, thus adding cost to the vehicle.

It would be desirable to produce a multi-zone temperature control system for an air handling system of a HVAC system for a vehicle, wherein a cost and a space requirement for the system are minimized and a control of temperature in a passenger compartment of the vehicle is optimized.

### SUMMARY OF THE INVENTION

Consistent and consonant with the present invention, a multi-zone temperature control system for an air handling system of a HVAC system for a vehicle, wherein a cost and a space requirement for the system are minimized and a control of temperature in a passenger compartment of the vehicle is optimized, has surprisingly been discovered.

In one embodiment, the multi-zone temperature control system comprises a temperature control module housing forming an air flow conduit therein, the temperature control module housing having a cold air inlet providing communication between a supply of cold air from the air handling system and the air flow conduit, a hot air inlet providing communication between a supply of hot air from the air handling system and the air flow conduit, and an outlet in communication with a passenger compartment of the vehicle; and a blend door disposed in the air flow conduit of the temperature control module housing, the blend door variably positionable between a first position and a second position, wherein the blend door permits a flow of cold air through the cold air inlet and militates against a flow of hot air through the hot air inlet when positioned in the first position, and the blend door permits a flow of hot air through the hot air inlet and militates against a flow of cold air through the cold air inlet when positioned in the second position, the blend door permitting a flow of both hot air and cold air when positioned intermediate the first position and the second position to supply a blend of hot air and cold air at a desired temperature to the passenger compartment of the vehicle.

In another embodiment, the multi-zone temperature control system comprises an air handling system housing having an inlet in communication with a supply of air and an outlet in communication with a passenger compartment of the vehicle, wherein the air handling system housing provides a cold air stream and a hot air stream; and a temperature control module having an air flow conduit formed therein, the air flow conduit having a blend door disposed therein, the temperature control module having a cold air inlet providing communication between the cold air stream and the air flow conduit, a hot air inlet providing communication between the hot air stream and the air flow conduit, and an outlet in communication with a passenger compartment of the vehicle, the blend door variably positionable between a first position and a second position, wherein the blend door permits a flow of cold air through the cold air inlet and militates against a flow of hot air through the hot air inlet when positioned in the first position, and the blend door permits a flow of hot air through the hot air inlet and militates against a flow of cold air through the cold air inlet when positioned in the second position, the blend door permitting a flow of both hot air and cold air when positioned intermediate the first position and the second position to supply a blend of hot air and cold air at a desired temperature to the passenger compartment of the vehicle.

In another embodiment, a multi-zone temperature control system comprises an air handling system housing having an inlet in communication with a supply of air and an outlet in communication with a passenger compartment of the vehicle, wherein the air handling system housing provides a cold air stream and a hot air stream; a temperature control module having an air flow conduit formed therein, the temperature control module having a cold air inlet providing communication between the cold air stream and the air flow conduit, a hot air inlet providing communication between the hot air stream and the air flow conduit, and an outlet in communication with a passenger compartment of the vehicle, the outlet of the temperature control module including a first outlet opening and a second outlet opening, wherein the air flow conduit includes a blend door disposed therein to control a mixing of the hot air stream and the cold air stream to reach a desired temperature of the air stream at the outlet of the temperature control module; and a mode door disposed in the air flow conduit, the mode door positionable in a first position and a second position, wherein the mode door militates against flow of air through the first outlet opening when positioned in the first position and militates against a flow of air through the second outlet opening when positioned in the second position.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is an exploded perspective view of a multi-zone temperature control system for an air handling system of a heating, ventilating, and air conditioning system for a vehicle according to an embodiment of the invention showing a top section, a multi-zone module, and a bottom section;

FIG. 2 is a top plan view of the bottom section of the multi-zone temperature control system of FIG. 1;

FIG. 3 is a perspective view of the bottom section and the multi-zone module of the multi-zone temperature control system of FIG. 1;

FIG. 4 is an exploded perspective view of the multi-zone module of FIG. 1;

FIG. 5 is a partial perspective view of the multi-zone module showing a bottom section and a blend door of the multi-zone module;

FIG. 6 is a partial perspective view of a multi-zone temperature control system for an air handling system of a heating, ventilating, and air conditioning system for a vehicle according to another embodiment of the invention showing a bottom section and a multi-zone module;

FIG. 7 is a partial perspective view of the multi-zone module of FIG. 6 showing a bottom section and a blend door of the multi-zone module; and

FIG. 8 is an exploded perspective view of the multi-zone module of FIG. 6.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

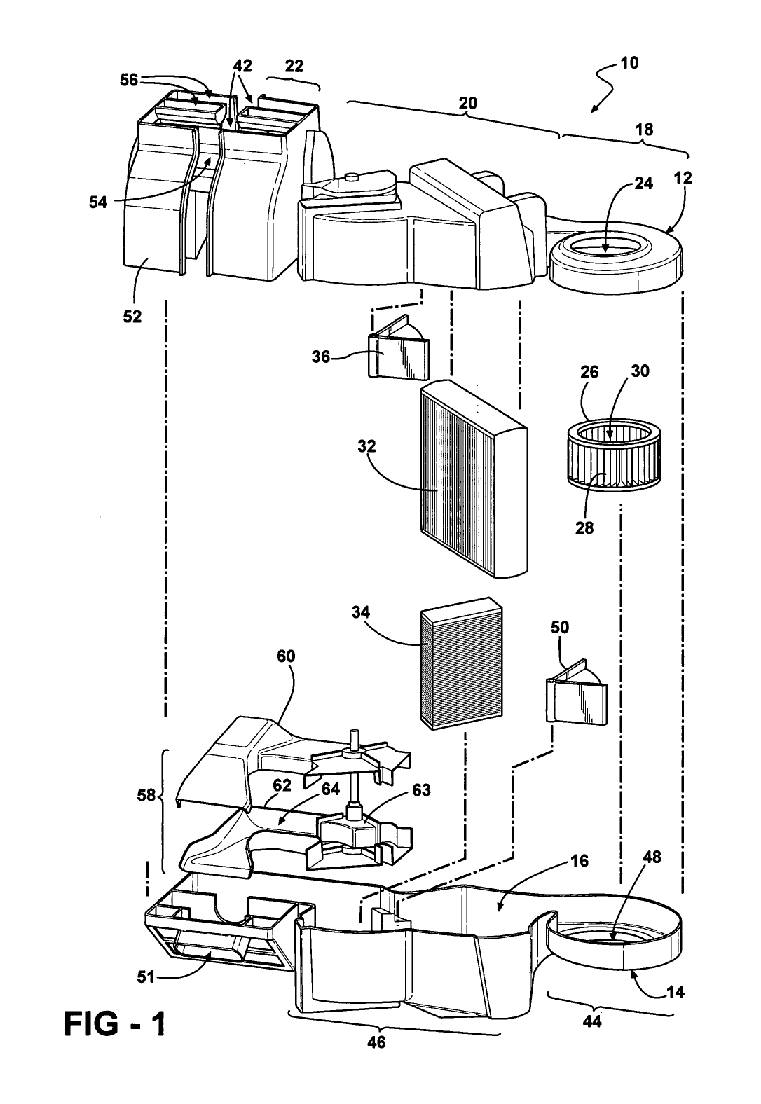

FIG. 1 shows an air handling system 10 of a heating, ventilating, and air conditioning (HVAC) system or climate control system (not shown) for a vehicle (not shown) according to an embodiment of the invention. The air handling system 10 is also commonly referred to as a HVAC air handling system in the art. Although the embodiment shown and described is a lateral or “handed” air handling system, it is understood that the invention can be used with other types of air handling systems as desired such as a center mount and semi-center mount, for example. The HVAC system typically provides heating, ventilation, and air conditioning for a passenger compartment (not shown) of the vehicle. The air handling system 10 is adapted to be installed under a dash panel (not shown) or an instrument panel (not shown) of the vehicle. The air handling system 10 includes an upper housing 12 and a lower housing 14. The upper housing 12 and the lower housing 14 cooperate to form a hollow main housing with an air flow conduit 16 formed therein.

The upper housing 12 includes an inlet section 18, a mixing and conditioning section 20, and an outlet and distribution section 22. An air inlet aperture 24 is formed in the inlet section 18, and is in fluid communication with a supply of air (not shown). If desired, a filter (not shown) can be provided upstream of the inlet section 18. The supply of air can be provided from outside of the vehicle, recirculated from the passenger compartment of the vehicle, or a mixture of the two, for example.

The inlet section 18 houses a blower wheel 26 therein. A motor (not shown) is coupled to the blower wheel 26 to impart rotational motion to the blower wheel 26. The motor can be any conventional type such as an electrically powered motor, for example. The blower wheel 26 includes a plurality of blades 28. The blades 28 cause air to be drawn from an inner opening 30 and expelled radially outwardly therefrom when the blower wheel 26 is rotating.

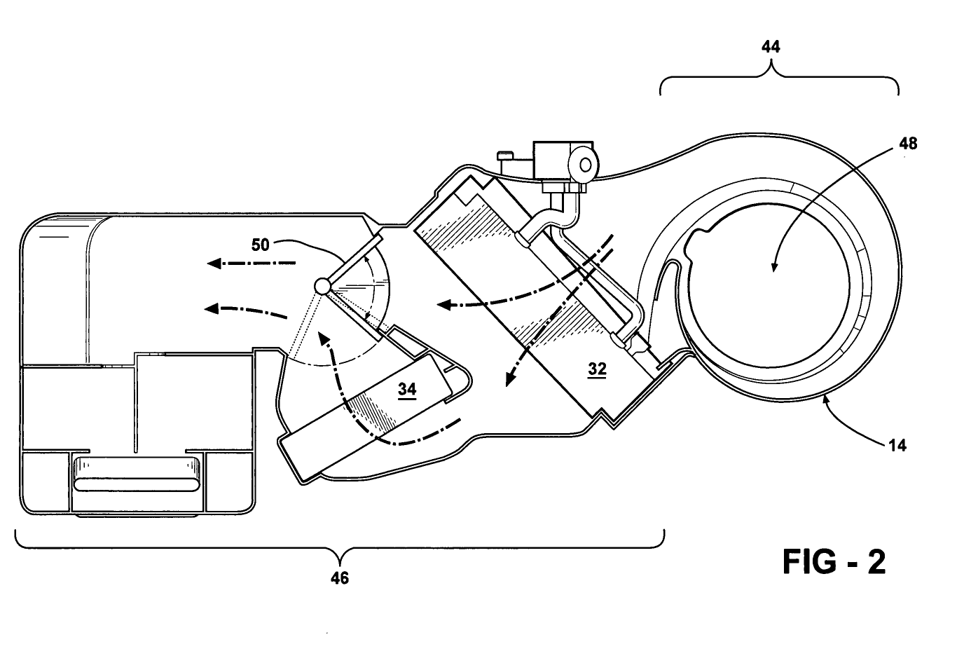

The mixing and conditioning section 20 receives an evaporator core 32, a heater core 34, and a blend door 36 therein. In the embodiment shown, the evaporator core 32 extends over the entire width and height of the air flow conduit 16, and the heater core 34 extends across only a portion of the air flow conduit 16, as shown in FIG. 2. If desired, a filter (not shown) can be provided upstream of the evaporator core 32. The blend door 36 is adapted to be connected to an actuator mechanism (not shown) such as an electrical positioning motor, for example, for controlling a position of the blend door 36. Any conventional blend door type can be used as desired.

The outlet and distribution section 22 includes a pair of air outlet apertures 42. The air outlet apertures 42 are in fluid communication with delivery conduits (not shown) for supplying conditioned air to and distributing conditioned air within the passenger compartment of the vehicle. In the embodiment shown, the air outlet apertures 42 supply conditioned air to the front seat area of the passenger compartment, although the air outlet apertures 42 can supply conditioned air to other areas of the passenger compartment as desired.

The lower housing 14 includes an inlet section 44 and a mixing and conditioning section 46. An air inlet aperture 48 is formed in the inlet section 44, and is in fluid communication with the supply of air. If desired, a filter (not shown) can be provided upstream of the inlet section 44. The supply of air can be provided from outside of the vehicle, recirculated from the passenger compartment of the vehicle, or a mixture of the two, for example.

The inlet section 44 houses the blower wheel 26 therein. The mixing and conditioning section 46 receives the evaporator core 32, the heater core 34, and a blend door 50 therein, as more clearly shown in FIG. 2. The blend door 50 is adapted to be connected to an actuator mechanism (not shown) such as an electrical positioning motor, for example, for controlling a position of the blend door 50. Any conventional blend door type can be used as desired. It is understood that the actuator mechanism can be electrically operated, mechanically operated, or vacuum operated, for example. A projection 51 is formed on the mixing and conditioning section 46 of the lower housing 14 at an end opposite the inlet section 44. An aperture or plenum is formed in an interior portion of the projection 51. The projection 51 is adapted to be connected to a delivery conduit (not shown) for supplying conditioned air to and distributing conditioned air within the passenger compartment of the vehicle. In the embodiment shown, the projection 51 and the delivery conduit cooperate to supply conditioned air from the air flow conduit 64 to a rear seat area of the passenger compartment. It is understood that the delivery conduit can supply conditioned air to other areas of the vehicle as desired.

An outlet and distribution section 52 is disposed on the lower housing 14 and abuts and is joined to the outlet and distribution section 22 of the upper housing 12. The outlet and distribution section 22 of the upper housing 12 and the outlet and distribution section 52 cooperate to form an air flow conduit 54 therebetween. A pair of air outlet apertures 56 is formed in the outlet and distribution section 52. The air outlet apertures 42, 56 provide fluid communication between the air flow conduit 16 and the delivery conduits for supplying conditioned air to and distributing conditioned air within the passenger compartment of the vehicle.

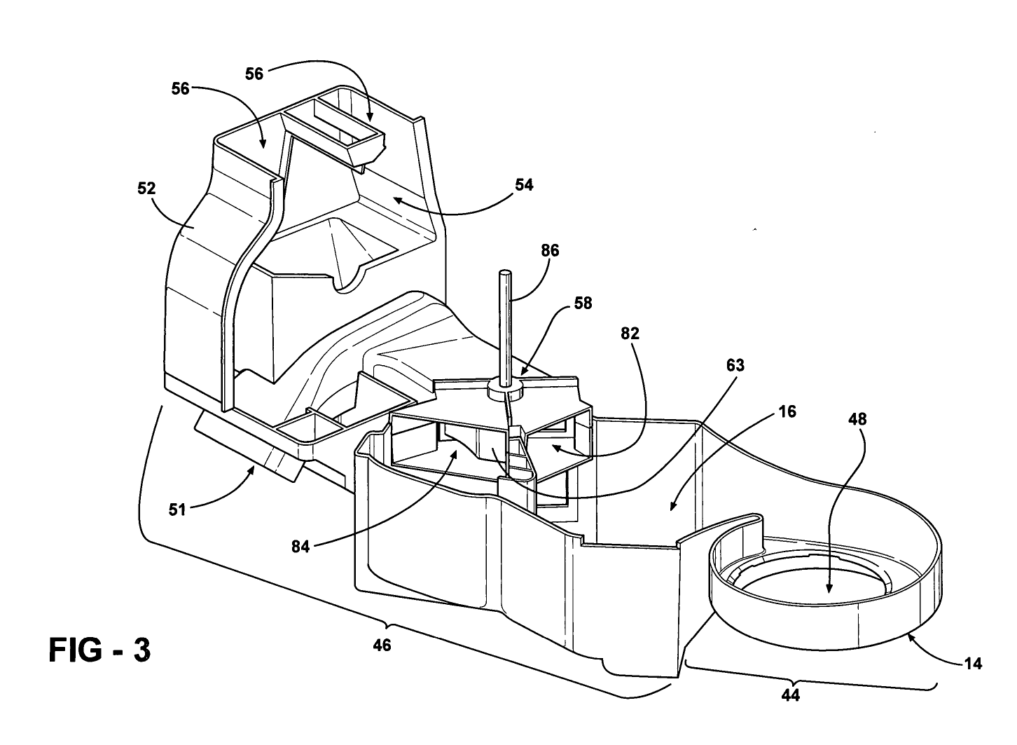

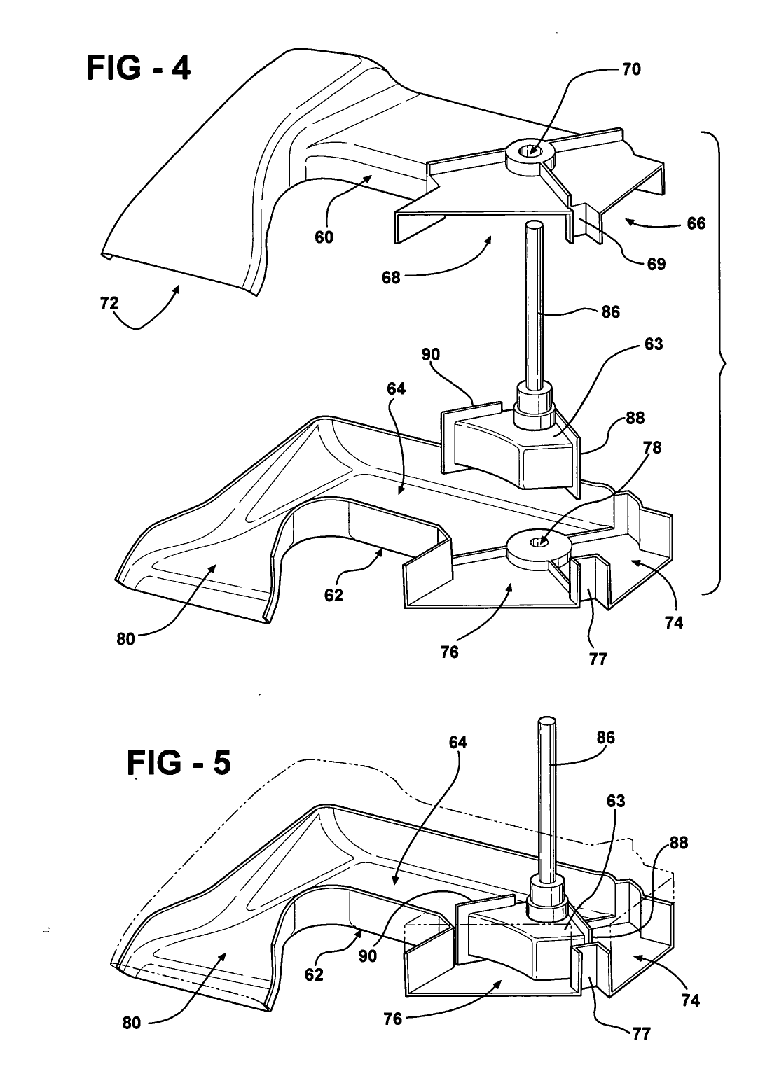

A multi-zone temperature control module 58 is disposed between the upper housing 12 and the lower housing 14 within the air flow conduit 16 as shown in FIGS. 1 and 3. A portion of the flow of air through the air flow conduit 16 is directed into the temperature control module 58. The temperature control module 58 includes an upper housing 60, a lower housing 62, and a blend door 63, as illustrated in FIG. 4. The upper housing 60 and the lower housing 62 cooperate to form a hollow main housing with an air flow conduit 64 formed therein.

The upper housing 60 includes a cold air inlet 66 and a hot air inlet 68 formed therein at a first end thereof. A center wall 69 is disposed between the cold air inlet 66 and the hot air inlet 68. An aperture 70 is formed in the upper housing 60 adjacent the cold air inlet 66 and the hot air inlet 68. An outlet 72 is formed at a second end of the upper housing 60. In the embodiment shown, the temperature control module 58 is substantially L-shaped in plan, wherein one arm of the L adjacent the outlet 72 extends downwardly. However, it is understood that temperature control modules having other shapes can be used without departing from the scope and spirit of the invention.

The lower housing 62 includes a cold air inlet 74 and a hot air inlet 76 formed therein at a first end thereof. A center wall 77 is disposed between the cold air inlet 74 and the hot air inlet 76. An aperture 78 is formed in the lower housing 62 adjacent the cold air inlet 74 and the hot air inlet 76. An outlet 80 is formed at a second end of the lower housing 62.

As shown in FIG. 3, the cold air inlet 66 of the upper housing 60 and the cold air inlet 74 of the lower housing 62 cooperate to form a cold air inlet opening 82 providing fluid communication between a cold air portion of the air flow conduit 16 formed by the upper housing 12 and the lower housing 14 of the air handling system 10 and the air flow conduit 64 of the temperature control module 58. The hot air inlet 68 of the upper housing 60 and the hot air inlet 76 of the lower housing 62 cooperate to form a hot air inlet opening 84 providing fluid communication between a hot air portion of the air flow conduit 16 formed by the upper housing 12 and the lower housing 14 of the air handling system 10 and the air flow conduit 64 of the temperature control module 58. The outlet 72 of the upper housing 60 and the outlet 80 of the lower housing 62 cooperate to form an outlet opening (not shown). The outlet opening of the temperature control module 58 provides fluid communication from the air flow conduit 64 of the temperature control module 58, through the projection 51, to the delivery conduit supplying the passenger compartment of the vehicle.

The blend door 63 is pivotally connected to an actuator rod 86. The actuator rod 86 is adapted to be connected to an actuator mechanism (not shown) such as an electrical positioning motor, for example, for controlling a position of the blend door 63. It is understood that the actuator mechanism can be electrically operated, mechanically operated, or vacuum operated, for example. One end of the actuator rod 86 is received in the aperture 70 of the upper housing 60 and the other end of the actuator rod 86 is received in the aperture 78 of the lower housing 62. The blend door 63 has a substantially V-shaped cross-section. A first leg of the V is formed by a first sealing surface 88 and a second leg of the V is formed by a second sealing surface 90. In the embodiment shown, the first sealing surface 88 and the second sealing surface 90 are disposed at an angle of substantially 90 degrees with one another, although the first sealing surface 88 and the second sealing surface 90 can be disposed at other angles relative to one another, if desired. It is understood that other blend door shapes and types can be used as desired.

In operation, the air handling system 10 conditions air by heating or cooling the air and providing the conditioned air to the passenger compartment of the vehicle. Air flows through the air handling system 10 through both the upper housing 12 and the lower housing 14. However, since the flow of air through the upper housing 12 and the lower housing 14 is substantially the same, only the flow of air through the lower housing 14 will be described herein. Referring now to FIG. 2, air from the supply of air is drawn into the air handling system 10 through the air inlet apertures 24, 48 by the blower wheel 26. During rotation of the blower wheel 26, the blades 28 of the blower wheel 26 cause the air to flow radially outwardly into the air flow conduit 16 in the inlet sections 18, 44 of the housings 12, 14.

The air then flows to the evaporator core 32 where the air is cooled to a desired temperature and dehumidified by transfer of heat from the air to a fluid (not shown) circulated through the evaporator core 32. The conditioned cooled air stream then exits the evaporator core 32. The blend door 50 is positioned as desired to cause the air to flow through the heater core 34, bypass the heater core 34, or some combination thereof. To cause the air to flow though the heater core 34, the blend door 50 is positioned in a first position as shown in FIG. 2. To cause the air to bypass the heater core 34, the blend door 50 is moved to a second position indicated by the dashed lines. If it is desired to cause the air to flow through the heater core 34 and to bypass the heater core 34, the blend door 50 is positioned intermediate the first position and the second position. Therefore, a portion of the air will be directed through the heater core 34 and a portion of the air will bypass the heater core 34.

In the heater core 34, the air is heated by transfer of heat from a fluid (not shown) circulated through the heater core 34. A temperature of the conditioned air stream downstream of the blend door 50 can be maintained as desired between a maximum temperature equal to the temperature of the hot air exiting the heater core 34 with the blend door 50 in the first position and a minimum temperature equal to the temperature of the air exiting the evaporator core 32 with the blend door 50 in the second position. If a temperature between the maximum temperature and the minimum temperature is desired, the blend door 50 is positioned intermediate the first position and the second position until the desired temperature is reached.

The conditioned air is then caused to exit the air handling system 10 through the outlet and distribution sections 22, 52 for delivery to and distribution in the passenger compartment of the vehicle. The conditioned air can be divided between the driver side and passenger side of the vehicle if desired by maintaining a division between the air flow through the upper housing 12 and the lower housing 14. As is known in the art, this can be accomplished by using a substantially horizontal divider plate (not shown) disposed between the upper housing 12 and the lower housing 14 for separating the conditioned air exiting the evaporator core 32 and the heater core 34, maintaining this separation through the outlet and distribution sections 22, 52 by a dividing wall (not shown), and delivering the conditioned air to the driver side and passenger side of the vehicle as desired. Additional blend doors (not shown) may be used to control the amount of conditioned air delivered separately to the driver side and passenger side of the vehicle.

In respect of the flow of air through the temperature control module 58, the cold air inlet opening 82 is in constant communication with the air exiting the evaporator core 32 and the hot air inlet opening 84 is in constant communication with the air exiting the heater core 34. Flow of air into the temperature control module 58 is controlled by the blend door 63. When the blend door 63 is in a first position as shown in FIG. 5, the second sealing surface 90 sealingly closes the hot air inlet opening 84 of the temperature control module 58 to militate against flow of air through the hot air inlet opening 84 and into the air flow conduit 64. In this position, the first sealing surface 88 cooperates with the center walls 69, 77 of the temperature control module 58 to militate against the flow of air from the hot air inlet opening 84 into the cold air inlet opening 82 and into the air flow conduit 64. Air is permitted to flow through the cold air inlet opening 82, into the air flow conduit 64, and to the delivery conduit supplying the passenger compartment of the vehicle.

If the blend door 63 is rotated from the first position counterclockwise to a stop point at a second position, the first sealing surface 88 sealingly closes the cold air inlet opening 82 of the temperature control module 58 to militate against flow of air through the cold air inlet opening 82 and into the air flow conduit 64. In this position, the second sealing surface 90 cooperates with the center walls 69, 77 of the temperature control module 58 to militate against the flow of air from the cold air inlet opening 82 into the hot air inlet opening 84 and into the air flow conduit 64. Air is permitted to flow through the hot air inlet opening 84, into the air flow conduit 64, and to the delivery conduit supplying the passenger compartment of the vehicle.

A temperature of the conditioned air downstream of the blend door 63 can be maintained as desired between a maximum equal to the temperature of the hot air entering the hot air inlet opening 84 with the blend door 63 in the second position and a minimum equal to the temperature of the air entering the cold air inlet opening 82 with the blend door 63 in the first position. If a temperature between the maximum temperature and the minimum temperature is desired, the blend door 63 is positioned intermediate the first position and the second position until the desired temperature is reached.

The conditioned air then exits the temperature control module 58 through the outlet opening, through the projection 51, to the delivery conduit supplying the passenger compartment for delivery to and distribution in the passenger compartment of the vehicle. The conditioned air exiting the temperature control module 58 provides a flow of conditioned air which is controlled separately from the air exiting the air handling system 10 through the air outlet apertures 42, 56. Therefore, separate control can be accomplished between a front seat portion and a back seat portion of the passenger compartment of the vehicle. Additionally, the air flow can be divided between the driver side and passenger side of the vehicle if desired by providing a dividing wall (not shown) in the outlet opening or the delivery conduit supplying the passenger compartment of the vehicle. Additionally, existing air handling systems can be retrofitted to provide this additional temperature control by removing the divider plate previously described with the temperature control module 58.

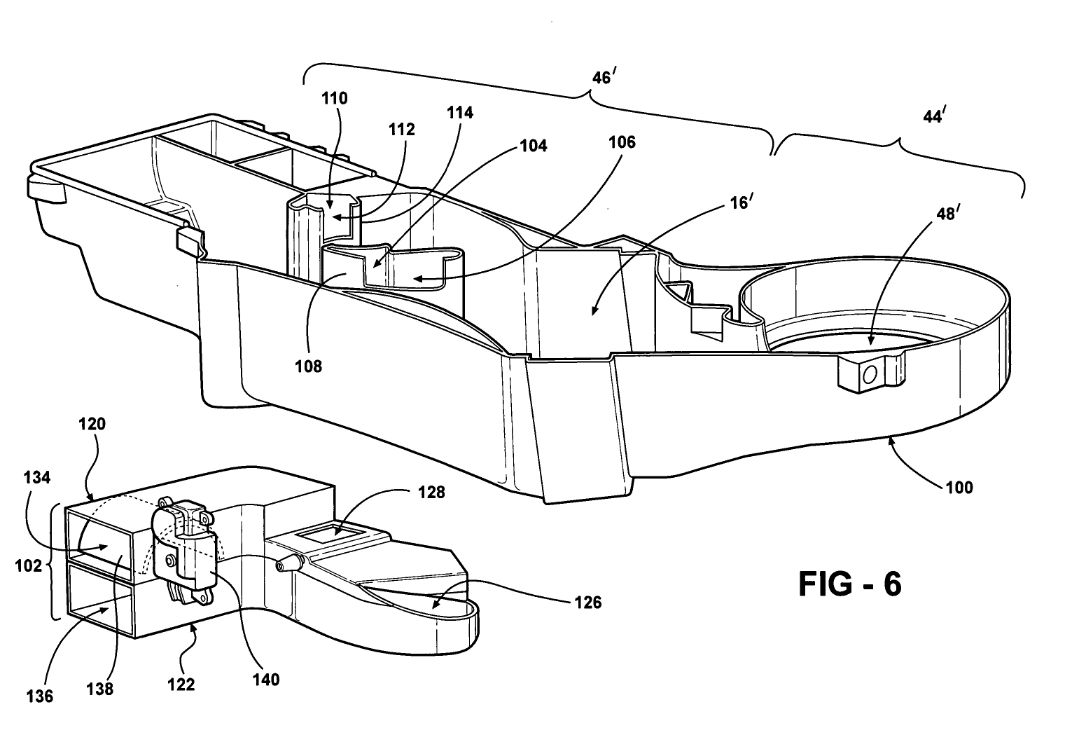

FIGS. 6-8 illustrate another embodiment of the invention. In the embodiment shown, only a lower housing 100 is shown, with a multi-zone temperature control module 102. The remaining structure illustrated in FIGS. 1-3 remains unchanged, except as noted herein. Like structure from FIGS. 1-5 has the same reference numeral and a prime (′) for clarity. The lower housing 100 is substantially similar to the lower housing 14 described above. However, the projection 51 is not formed on the lower housing 100. The lower housing 100 is adapted to be connected to an upper housing (not shown) as previously described and shown for the previous embodiment to form an air flow conduit 16′ therebetween. It is understood that the temperature control module 102 can be provided as shown with the air handling system or retrofitted on an existing air handling system.

In the lower housing 100, a cold air chamber 104 is provided downstream of and adjacent an evaporator core (not shown). A cold air inlet 106 is formed in an outer wall 108 of the cold air chamber 104. The cold air inlet 106 provides fluid communication between the air downstream of the evaporator core and upstream of a heater core (not shown) and the cold air chamber 104. Existing chambers in an air handling system housing downstream of the evaporator core and upstream of the heater core can be utilized as the cold air chamber 104, if desired.

A hot air chamber 110 is formed in the lower housing 100 downstream of the heater core. A hot air inlet 112 is formed in an outer wall 114 of the hot air chamber 110. Existing chambers in an air handling system housing downstream of the heater core can be utilized as the hot air chamber 110, if desired.

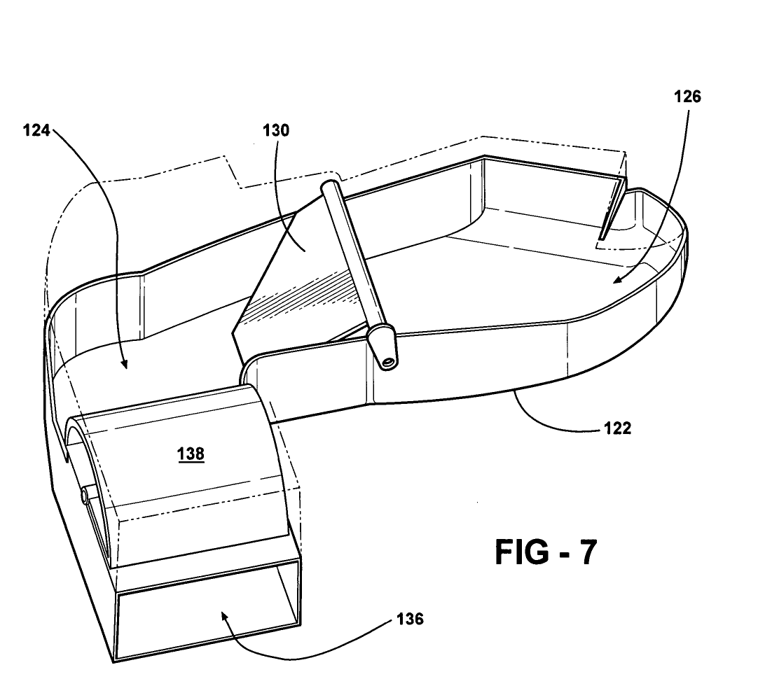

The multi-zone temperature control module 102 is disposed beneath the lower housing 100. The temperature control module 102 includes an upper housing 120 and a lower housing 122 which cooperate to form a hollow main housing having an air flow conduit 124 formed therein, as illustrated in FIG. 7. In the embodiment shown, the temperature control module 102 is substantially L-shaped in plan. However, it is understood that temperature control modules having other shapes can be used without departing from the scope and spirit of the invention.

The lower housing 122 includes a cold air inlet opening 126 formed therein adjacent a first end thereof. The upper housing 120 includes a hot air inlet opening 128 formed therein adjacent a first end thereof and downstream of the cold air inlet opening 126. The cold air inlet opening 126 provides fluid communication between an outlet (not shown) of the cold air chamber 104 and the air flow conduit 124. It is understood that a connection conduit (not shown) can be disposed between the outlet of the cold air chamber 104 and the cold air inlet opening 126. Fluid communication between an outlet (not shown) of the hot air chamber 110 and the air flow conduit 124 is provided by the hot air inlet opening 128. It is understood that a connection conduit (not shown) can be disposed between the outlet of the hot air chamber 110 and the hot air inlet opening 128.

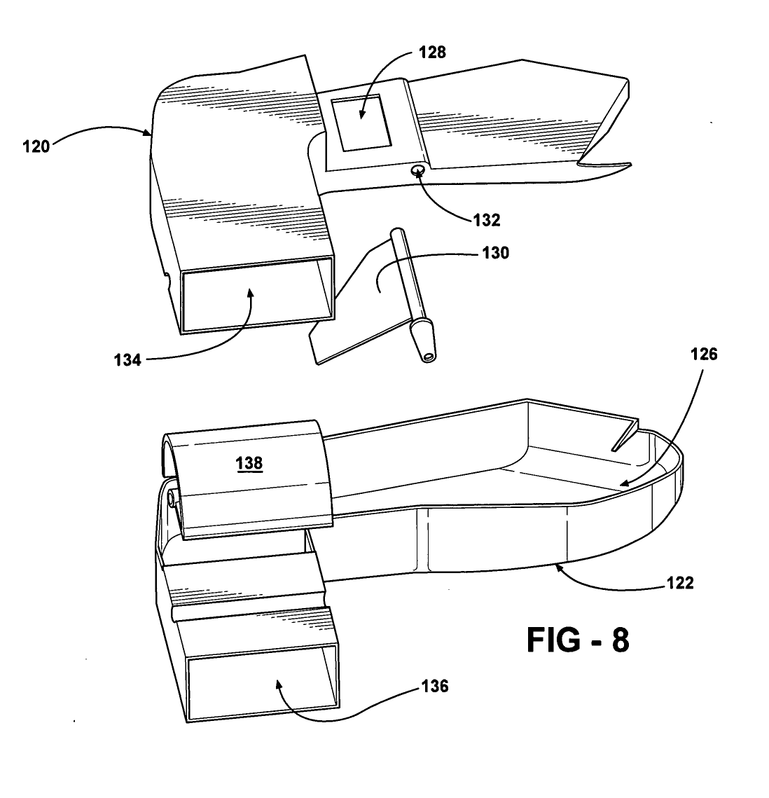

A substantially planar blend door 130 is pivotally disposed in the air flow conduit 124 between the cold air inlet opening 126 and the hot air inlet opening 128, as illustrated in FIGS. 7 and 8. In the embodiment shown, the blend door 130 is pivotally supported in apertures 132 formed in the upper housing 120. However, it is understood that the blend door 130 can be supported otherwise such as by the lower housing 122, for example. Additionally, it is understood that other blend door types such as non-planar, for example, can be used without departing from the scope and spirit of the invention. The blend door 130 is adapted to be connected to an actuator mechanism (not shown) such as an electrical positioning motor, for example, for controlling a position of the blend door 130. It is understood that the actuator mechanism can be electrically operated, mechanically operated, or vacuum operated, for example.

A first outlet opening 134 is formed at a second end of the upper housing 120 and a second outlet opening 136 is formed at a second end of the lower housing 122. The outlet openings 134, 136 provide fluid communication between the air flow conduit 124 of the temperature control module 102 and a delivery conduit (not shown) supplying the passenger compartment of the vehicle.

A semi-cylindrical mode door 138 having a semi-circular cross-section is disposed in the air flow conduit 124 adjacent the outlet openings 134, 136. In the embodiment shown, the mode door 138 is rotatably supported by the upper housing 120 and the lower housing 122 and is adjustably rotatable between a first position in the upper housing 120 and a second position in the lower housing 122. However, it is understood that other mode door types can be used such as a substantially planar door similar in structure to the blend door 130, for example, without departing from the scope and spirit of the invention. The mode door 138 is operably connected to an actuator mechanism 140 for controlling a position of the mode door 138. The actuator mechanism 140 can be any conventional type such as an electrical positioning motor, for example. It is understood that the actuator mechanism 140 can be electrically operated, mechanically operated, or vacuum operated, for example. The mode door 138 of the current embodiment can also be provided with the temperature control module 58 of the embodiment previously shown and described.

The operation of the temperature control module 102 is substantially the same as the air handling system 10 and temperature control module 58 previously described, except as indicated. Air is conditioned by heating or cooling the air and providing the conditioned air to the passenger compartment of the vehicle. The air flows through the evaporator core where the air is cooled to a desired temperature and dehumidified. The air is then caused to flow as desired through the heater core, to bypass the heater core, or some combination thereof. The air directed through the heater core is heated.

The cold air inlet opening 126 is in constant communication with the air exiting the evaporator core and the hot air inlet opening 128 is in constant communication with the air exiting the heater core. Flow of air into the temperature control module 102 is controlled by the blend door 130. When the blend door 130 is in a first position which is substantially horizontal, the blend door 130 sealingly closes the hot air inlet opening 128 of the temperature control module 102 to militate against flow of air through the hot air inlet opening 128 and into the air flow conduit 124. Air is permitted to flow through the cold air inlet opening 126, into the air flow conduit 124, and to the delivery conduit supplying the passenger compartment of the vehicle. When the blend door 130 is rotated from the first position counterclockwise approximately 90 degrees to a second position which is substantially vertical, the blend door 130 sealingly closes the cold air inlet opening 126 of the temperature control module 102 to militate against flow of air through the cold air inlet opening 126 and into the air flow conduit 124. Air is permitted to flow through the hot air inlet opening 128, into the air flow conduit 124, and to the delivery conduit supplying the passenger compartment of the vehicle.

A temperature of the conditioned air downstream of the blend door 130 can be maintained as desired between a maximum equal to the temperature of the hot air entering the hot air inlet opening 128 with the blend door 130 in the second position and a minimum equal to the temperature of the air entering the cold air inlet opening 126 with the blend door 130 in the first position. If a temperature between the maximum temperature and the minimum temperature is desired, the blend door 130 is positioned intermediate the first position and the second position until the desired temperature is reached.

The conditioned air then flows to the mode door 138. Flow of conditioned air out of the control module 102 is controlled by the mode door 138. When the mode door 138 is positioned in a first position in the first outlet opening 134 of the upper housing 120 as shown in FIG. 6, the mode door 138 sealingly closes the first outlet opening 134 to militate against flow of air therethrough. Air is permitted to flow through the second outlet opening 136 of the lower housing 122 and into the delivery conduit supplying the passenger compartment of the vehicle. When the mode door 138 is rotated from the first position to a second position sealingly closing the second outlet opening 136 of the lower housing 122, the mode door 138 militates against flow of air through the second outlet opening 136. Air is permitted to flow through the first outlet opening 134 of the upper housing 120 and into the delivery conduit supplying the passenger compartment of the vehicle.

As previously described, the temperature control module 102 allows for separate control between a front seat portion and a back seat portion of the passenger compartment of the vehicle. Additionally, the air flow can be supplied to either a head area or a foot area, or the driver side or passenger side of the vehicle by controlling flow out of the outlet openings 134, 136 and providing a divided delivery conduit supplying the passenger compartment of the vehicle. By positioning the mode door 138 at a point intermediate the first position and the second position, flow through both the outlet openings 134, 136 is militated against.

The embodiments of the invention described herein minimize a cost of providing control and conditioning of air supplied to multiple zones of the passenger compartment of the vehicle. Providing the temperature control modules 58, 102 eliminate the need for a separate air handling system for the rear seat area of the passenger compartment, or other areas. The temperature control modules 58, 102 utilize the main air handling system for the vehicle to supply other zones. By eliminating the need for the separate air handling system, weight and packaging requirements for the vehicle are also minimized. The temperature control modules 58, 102 have been found to be especially useful in lateral air handling systems, such as shown and described herein, where the layout and design of the system makes it more difficult to convey the hot and cold air streams to an area where the air can be routed to the rear seating area.

Since the temperature control modules 58, 102 are supplied by hot and cold zones of the main air handling system for the vehicle, the temperature control modules 58, 102 can be produced separately from the main air handling system. Therefore, the temperature control modules 58, 102 can be added to the main air handling system where supply of conditioned air to an additional zone in the vehicle is desired. Accordingly, the flexibility and functionality of the main air handling system of the vehicle is maximized when the system is expanded from supplying one or two zones to three or more. This expansion is accomplished with minimal modification to the main air handling system.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A temperature control module for an air handling system of a heating, ventilating, and air conditioning system for a vehicle comprising:
a temperature control module housing forming an air flow conduit therein, said temperature control module housing having a cold air inlet providing communication between a supply of cold air from the air handling system and the air flow conduit, a hot air inlet providing communication between a supply of hot air from the air handling system and the air flow conduit, and an outlet in communication with a passenger compartment of the vehicle; and
a blend door disposed in the air flow conduit of said temperature control module housing, said blend door variably positionable between a first position and a second position, wherein said blend door permits a flow of cold air through the cold air inlet and militates against a flow of hot air through the hot air inlet when positioned in the first position, and said blend door permits a flow of hot air through the hot air inlet and militates against a flow of cold air through the cold air inlet when positioned in the second position, said blend door permitting a flow of both hot air and cold air when positioned intermediate the first position and the second position to supply a blend of hot air and cold air at a desired temperature to the passenger compartment of the vehicle.

2. The module according to claim 1, wherein said housing includes an upper housing and a lower housing.

3. The module according to claim 1, wherein said blend door is pivotally mounted to said housing to pivot between the first position and the second position.

4. The module according to claim 1, wherein said blend door is substantially V-shaped.

5. The module according to claim 4, wherein said blend door includes a first sealing surface and a second sealing surface disposed at an angle of about 90 degree apart.

6. The module according to claim 1, wherein said housing is substantially L-shaped.

7. The module according to claim 1, wherein said blend door is substantially planar.

8. The module according to claim 1, wherein the outlet includes a first outlet opening and a second outlet opening.

9. The module according to claim 8, further comprising a mode door disposed in the air flow conduit, said mode door positionable in a first position and a second position, wherein said mode door militates against flow of air through the first outlet opening when positioned in the first position and militates against a flow of air through the second outlet opening when positioned in the second position.

10. An air handling system of a heating, ventilating, and air conditioning system for a vehicle comprising:
an air handling system housing having an inlet in communication with a supply of air and an outlet in communication with a passenger compartment of the vehicle, wherein said air handling system housing provides a cold air stream and a hot air stream; and
a temperature control module having an air flow conduit formed therein, the air flow conduit having a blend door disposed therein, said temperature control module having a cold air inlet providing communication between the cold air stream and the air flow conduit, a hot air inlet providing communication between the hot air stream and the air flow conduit, and an outlet in communication with a passenger compartment of the vehicle, the blend door variably positionable between a first position and a second position, wherein the blend door permits a flow of cold air through the cold air inlet and militates against a flow of hot air through the hot air inlet when positioned in the first position, and the blend door permits a flow of hot air through the hot air inlet and militates against a flow of cold air through the cold air inlet when positioned in the second position, the blend door permitting a flow of both hot air and cold air when positioned intermediate the first position and the second position to supply a blend of hot air and cold air at a desired temperature to the passenger compartment of the vehicle.

11. The system according to claim 10, wherein said temperature control module is disposed in said air handling system housing.

12. The system according to claim 10, wherein said temperature control module is disposed outside of said air handling system housing.

13. The system according to claim 10, wherein the blend door is pivotally mounted within the air flow conduit to pivot between the first position and the second position.

14. The system according to claim 10, wherein the outlet of said temperature control module includes a first outlet opening and a second outlet opening.

15. The system according to claim 14, wherein said temperature control module includes a mode door disposed in the air flow conduit, the mode door positionable in a first position and a second position, wherein the mode door militates against flow of air through the first outlet opening when positioned in the first position and militates against a flow of air through the second outlet opening when positioned in the second position.

16. The system according to claim 15, wherein the mode door militates against flow of air through both the first outlet opening and the second outlet opening when positioned in a position intermediate the first position and the second position.

17. An air handling system of a heating, ventilating, and air conditioning system for a vehicle comprising:
an air handling system housing having an inlet in communication with a supply of air and an outlet in communication with a passenger compartment of the vehicle, wherein said air handling system housing provides a cold air stream and a hot air stream;
a temperature control module having an air flow conduit formed therein, said temperature control module having a cold air inlet providing communication between the cold air stream and the air flow conduit, a hot air inlet providing communication between the hot air stream and the air flow conduit, and an outlet in communication with a passenger compartment of the vehicle, the outlet of said temperature control module including a first outlet opening and a second outlet opening, wherein the air flow conduit includes a blend door disposed therein to control a mixing of the hot air stream and the cold air stream to reach a desired temperature of the air stream at the outlet of the temperature control module; and
a mode door disposed in the air flow conduit, said mode door positionable in a first position and a second position, wherein said mode door militates against flow of air through the first outlet opening when positioned in the first position and militates against a flow of air through the second outlet opening when positioned in the second position.

18. The system according to claim 17, wherein said mode door militates against flow of air through both the first outlet opening and the second outlet opening when positioned in a position intermediate the first position and the second position.

19. The system according to claim 17, wherein said temperature control module is disposed in said air handling system housing.

20. The system according to claim 17, wherein said temperature control module is disposed outside of said air handling system housing.
